(19) United States
(12) Patent Application Publication
(10) Pub. No.: US 2010/0307283 A1
(43) Pub. Date: Dec. 9, 2010

(54) Operating Lever for a Wind-Surfing or Kite Board

(76) Inventor: Jen-Chuan LIU, Nantou County (TW)

Correspondence Address: Dr. BANGER SHIA;Patent Office of Bang Shia, 102 Lindencrest Ct., Sugar Land, TX, 77479-5201, US

(21) Appl. No.: 12/605,314

(22) Filed: Oct. 23, 2009

(30) Foreign Application Priority Data
Jun. 3, 2009 (TW) 098209734

(51) Int. Cl. G05G 1/04

(52) U.S. Cl. 74/523

(57) ABSTRACT

An operating lever for a wind-surfing or kite board is a two-layer hollow water-drop-shaped pipe. With the water drop shape, the operating lever can be stably gripped by the user, and the undesired slippage of the operating lever can be avoided, so that the user can grip the operating lever more effortlessly. The two-layer hollow structure enhances the structure strength of the operating lever, so that the operating lever can be made of aluminum material without causing the increase of cost.

### BACKGROUND OF THE INVENTION

1. Field of the Invention

The present invention relates to an operating device for a wind driven vessel; and more particularly to an operating lever for a wind-surfing or kite board which has enough structure strength and can be gripped by the user more effortlessly.

2. Description of the Prior Art

Referring to FIGS. 1-2, a conventional operating lever 10 for a wind-surfing or kite board is cylinder-shaped. In order to reduce the weight and cost, the operating lever 10 is normally formed into a hollow cylinder and made of aluminum material. However, since the aluminum material is relatively soft, and the operating lever 10 is hollow, so that the structure strength of the operating lever 10 is obviously insufficient, thus correspondingly reducing the service life of the operating lever 10. In order to solve the above drawbacks, carbon fiber is used to make the operating lever 10, due to the characteristics of the carbon fiber, the operating lever 10 is light weight having a strengthened structure strength. However, it is to be noted that carbon fiber is too expensive, so the cost of the operating rod 10 is inevitably greatly increased.

Further referring to FIG. 3, when the user grips the cylinder-shaped operating lever 10, intense action and humid environment on the sea will make the operating lever 10 slippery and difficult to grip. Therefore, the user must grip the operating lever 10 with great force to avoid the occurrence of slippage, but inevitably, the hands of the user will still rotate and slip on the cylinder-shaped operating lever 10, thus reducing the operating stability, meanwhile, since the user must grip the operating lever 10 with great force, which makes the user fatigue easily, and as a result, the user is unable to enjoy surfing for a long time.

The present invention has arisen to mitigate and/or obviate the afore-described disadvantages.

### SUMMARY OF THE INVENTION

The primary objective of the present invention is to provide an operating lever for a wind-surfing or kite board which can be gripped stably by the user, and griping the operating lever is effortless, in addition, the structure design of the operating lever can provide enough structure strength, so that the operating lever can be made of aluminum material without causing the increase of cost.

In order to achieve the above objective, an operating lever for a wind-surfing or kite board in accordance with the present invention is formed into a ring shape, and the cross section of the operating lever is water-drop-shaped, the operating lever comprises a first portion and a second portion. The first portion at least includes a connecting side, and the second portion is a cone protruding from a portion adjacent to the connecting side toward one side of the operating lever, so that the connecting side of the first portion stretches across the inside of the operating lever, and the first portion and the second portion constitute a at-least-two-layer-water-drop shape. With the water-drop shape, the operating lever can be more stably gripped by the user, so that the user can grip the operating lever more effortlessly. The two-layer structure enhances the structure strength of the operating lever, so that the operating lever can be made of a common material or aluminum material without causing the increase of cost.

### BRIEF DESCRIPTION OF THE DRAWINGS

FIG. 1 is a partially perspective cross-sectional view of a conventional operating lever;

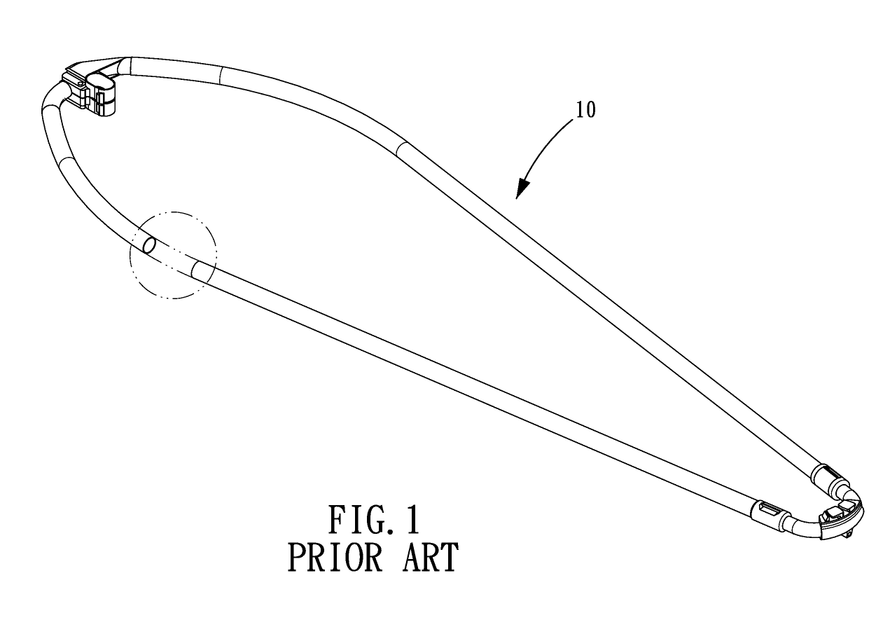

FIG. 2 is a partial enlarged view of the conventional operating lever of FIG. 1;

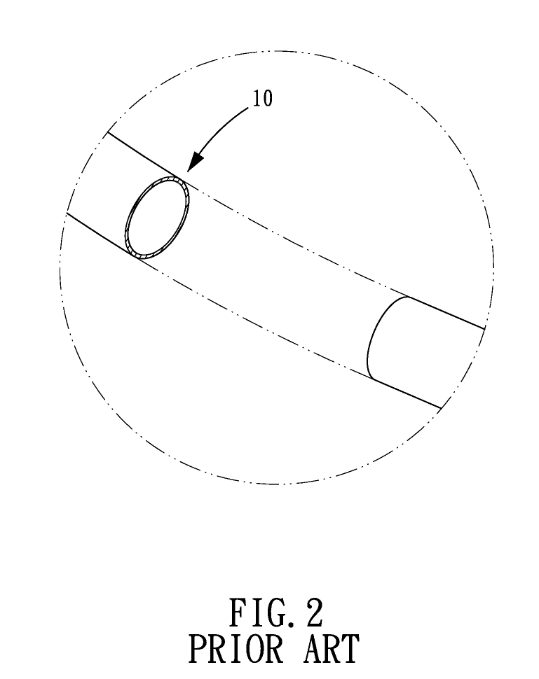

FIG. 3 is a cross-sectional view showing how the user grips the conventional operational lever of FIG. 1;

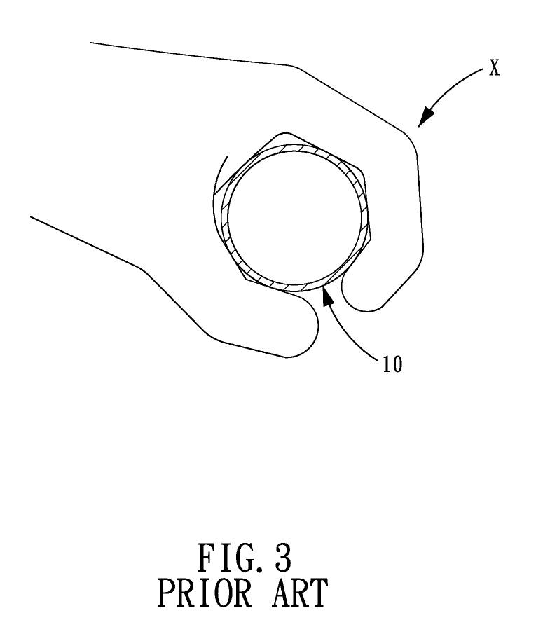

FIG. 4 is a partially perspective cross-sectional view of an operating lever for a wind-surfing board or a kite board in accordance with the present invention;

FIG. 5 is a partial enlarged view of FIG. 4;

FIG. 6 is a schematic view showing that the operating lever in accordance with the present invention is applied to a wind-surfing board;

FIG. 7 is a cross-sectional view showing the user grips the operating lever in accordance with the present invention;

FIG. 8 is a schematic view showing that the operating lever in accordance with the present invention is applied to a kite board; and

FIG. 9 is a partial enlarged view of FIG. 8.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

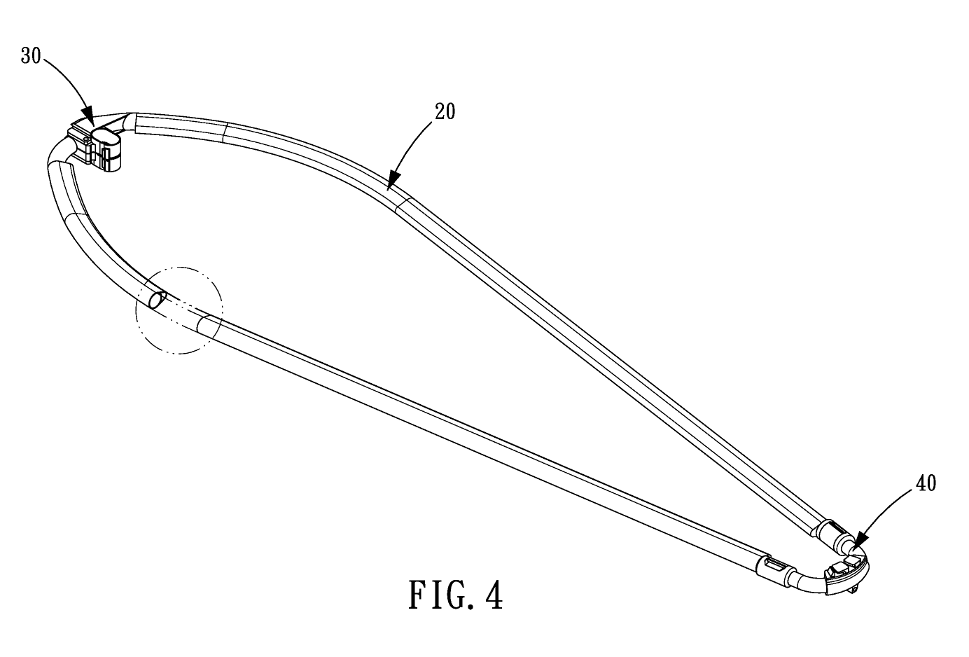

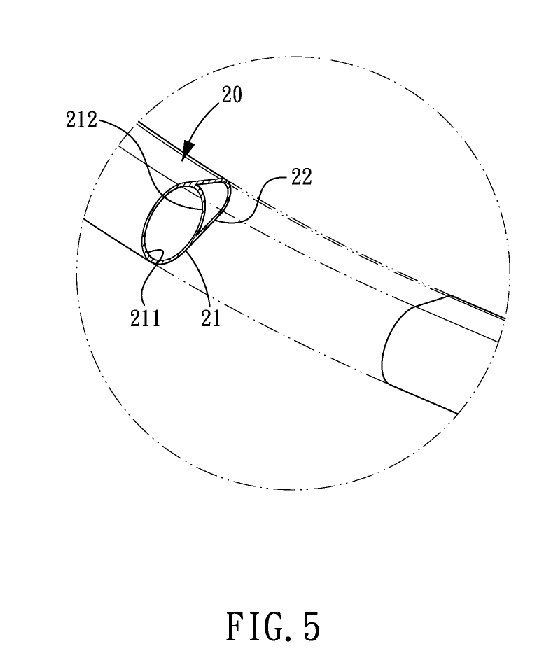

Referring to FIGS. 4-5 showing an operating lever for a wind-surfing or kite board in accordance with a preferred embodiment of the present invention, the operating lever 20 of the present invention is made by bending aluminum pipe into a ring shape. The operating lever 20 is provided with a front rudder 30 and a rear rudder 40.

The operating lever 20 is water-drop-shaped in cross section and comprises a first portion 21 and a second portion 22. The first portion 21 is hollow cylinder-shaped and includes a circumferential side 211 and a connecting side 212 which together constitute a complete circle. The second portion 22 is a cone protruding from connecting portions of the circumferential side 211 and the connecting side 212, by such an arrangement, the connecting side 212 of the first portion 21 stretches across the inside of the operating lever 20, and the circle of the first portion 21 and the cone of the second portion 22 constitute a two-layer-structured water drop shape. The second portion 22 of the operating lever 20 is located at the inner side of the operating lever 20, and the first portion 21 is located at the outer side of the operating lever 20.

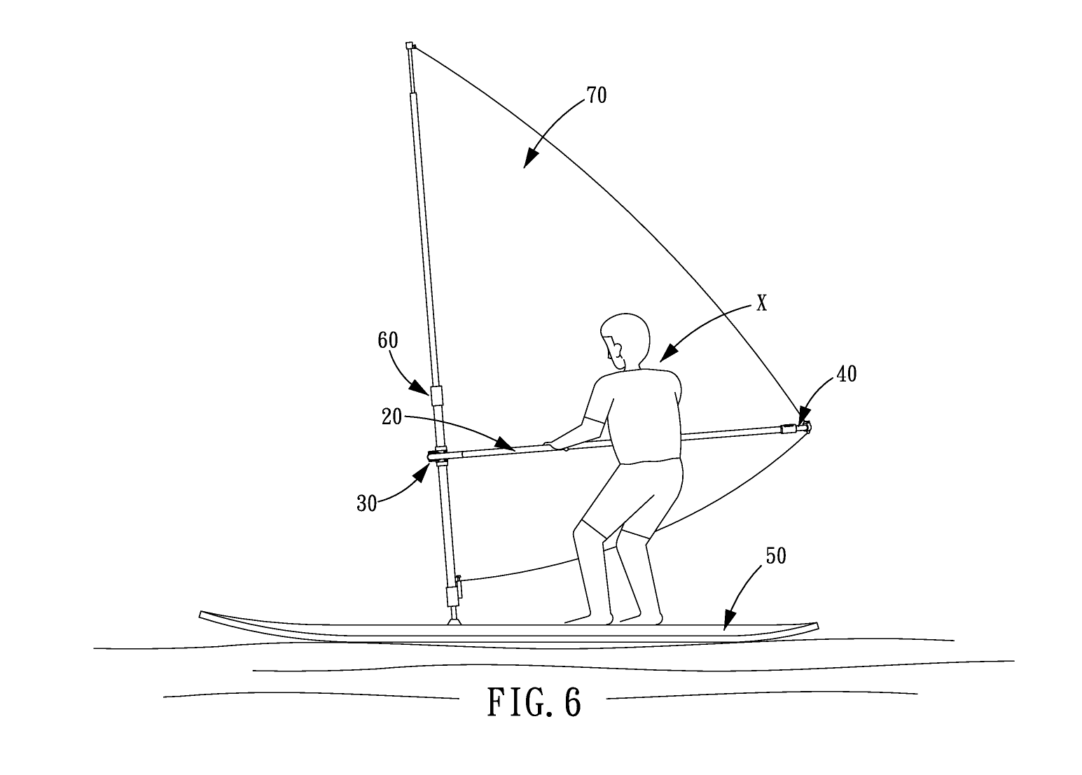

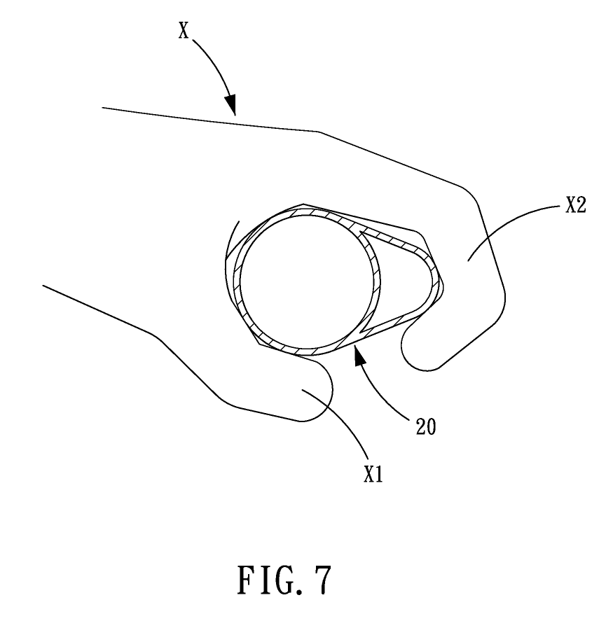

When the operating lever 20 is applied to a wind-surfing board, as shown in FIG. 6, the wind-surfing board includes a surfboard 50, a mast 60 and a sail 70, the mast 60 is inserted into the surfboard 50, the sail 70 is disposed on the mast 60 and then the operating lever 20, and the front rudder 30 and the rear rudder 40 of the operating lever 20 are provided for connection to a drawing string and the mast 60, so that the user can control the direction of the mast 60 and the sail 70 through the operating lever 20 while standing on the surfboard 50 and griping the operating lever 20. Further referring to FIG. 7, since the second portion 22 of the operating lever 20 is located at the inner side of the operating lever 20, when the user grips the operating lever 20, the user X will use his thumb to abut against the circular first portion 21 and other four fingers to abut against the second portion 22, so that the fingers of the user X can hook on the conical second portion 22. Since the operating lever 20 is non-circular, it prevents undesired slippage and rotation when the user X grips the operating lever 20, and the fingers hooking on the second portion 22 allows the user X to grip the operating lever 20 more firmly, so that the operating lever 20 won't slip from the user X easily. Therefore, with the operating lever of the present invention, the wind-surfing board can be operated more smoothly and stably, further correspondingly improving the operating performance.

In addition, since the user X can hook on the water-drop-shaped operating lever 20 to avoid the slippage of the operating lever 20, the user can do the surfing more effortlessly without having to keep applying great force to grip the operating lever 20 all the time.

Furthermore, the operating lever 20 comprises a first portion 21 and a second portion 22 that are integrally formed into a two-layer hollow pipe which has a water-drop-shaped cross section. The connecting side 212 of the first portion 21 stretches across the inside of the operating lever 20, so that the operating lever 20 is not fully hollow, and the connecting side 212 stretching across the inside of the operating lever 20 increases the structure strength of the inner side of the operating lever 20. Since the connecting side 212 supports at the inner side of the operating lever 20, the structure strength of the operating lever 20 is enhanced, correspondingly extending the service life of the operating lever 20. Further since the connecting side 212 increases the structure strength of the operating lever 20, the operating lever 20 can be made of aluminum material without compromising the structure strength, thus avoiding increasing production cost while improving the economic efficiency.

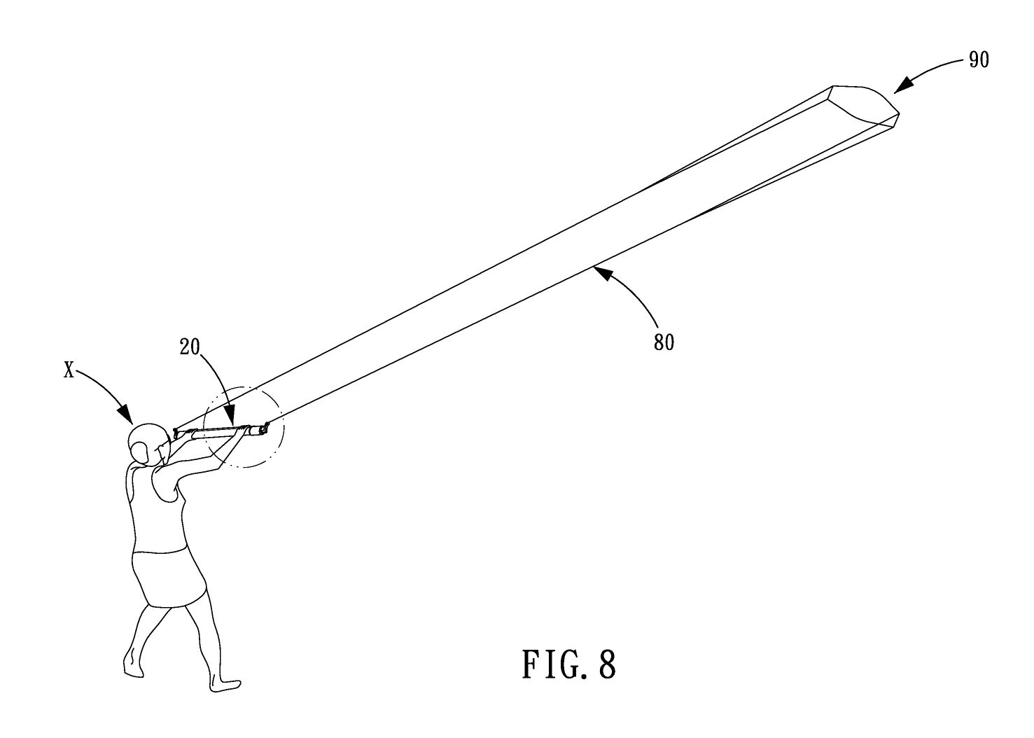

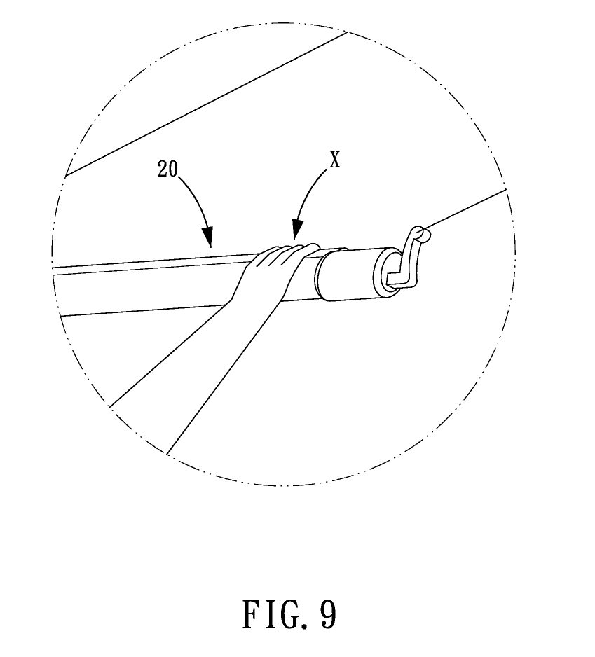

Moreover, the operating lever 20 not only can be applied to the wind-surfing board, but, as shown in FIGS. 8-9, can be applied to a kite board. The kite board comprises a drawing string 80 and a kite body 90. The drawing string 80 is connected to the operating lever 20 and the kite body 90, so that the user can grip the operating lever 20 to draw the kite body 90 to operate the kite board. Likewise, the operating lever can also achieve the same functions as described above.

To summarize, the operating lever of the present invention assuredly has the following advantages:

1. The water-drop-shaped operating lever 20 avoids undesired slippage and rotation to enhance the griping stability and further improve the operating performance in use.

2. The hands of the user can hook on the water-drop-shaped operating lever 20 to enhance the griping stability without having to keep applying great force to grip the operating lever 20 all the time.

3. The connecting side 212 of the first portion 21 of the operating lever 20 makes the operating lever 20 not fully hollow, and the connecting side 212 increases the structure strength of the inner side of the operating lever 20, so that the operating lever of the present invention can be made of aluminum material without compromising the structure strength, thus avoiding increasing production cost while improving the economic efficiency.

While we have shown and described various embodiments in accordance with the present invention, it is clear to those skilled in the art that further embodiments may be made without departing from the scope of the present invention.

What is claimed is:

1. An operating lever for a wind-surfing or kite board being formed into a ring shape and comprising a first portion and a second portion, the first portion being hollow cylinder-shaped and including a circumferential side and a connecting side which together constitute a complete circle, the second portion being a cone protruding from connecting portions of the circumferential side and the connecting side, the first portion and the second portion constituting a water drop shape, and the connecting side of the first portion stretching across an inside of the operating lever to make the operating lever have two layers.

2. The operating lever for a wind-surfing or kite board as claimed in claim 1, wherein the second portion of the operating lever is located at an inner side of the operating lever, and the first portion of the operating lever is located at an outer side of the operating lever.

3. The operating lever for a wind-surfing or kite board as claimed in claim 1, wherein the operating lever is applied to a wind-surfing board, the wind-surfing board comprises a surfboard, a mast and a sail, the mast is inserted into the surfboard, and the sail is disposed on the mast and then the operating lever, so that the user controls a direction of the mast and the sail through the operating lever.

4. The operating lever for a wind-surfing or kite board as claimed in claim 3, wherein the operating lever is further provided with a front rudder and a rear rudder for connection to a drawing string and the mast.

5. The operating lever for a wind-surfing or kite board as claimed in claim 1, wherein the operating lever is applied to a kite board, the kite board comprises a drawing string and a kite body, the drawing string is connected to the operating lever and the kite body, the operating lever is gripped by user to draw the kite body to operate the kite board.
